(19) United States
(12) Patent Application Publication
(10) Pub. No.: US 2010/0325153 A1
(43) Pub. Date: Dec. 23, 2010

(54) SYNCHRONIZED DISTRIBUTED MEDIA ASSETS

(75) Inventors: Pulin J. Thakkar, Redmond, WA (US); Praful P. Chavda, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/486,168

(22) Filed: Jun. 17, 2009

(51) Int. Cl. G06F 17/30; G06F 7/00; G06F 12/00

(52) U.S. Cl. 707/770; 709/231; 707/912; 707/955; 707/704; 707/957

(57) ABSTRACT

Synchronized distributed media assets is described. In embodiments, a global media catalog of global metadata is maintained for media assets that are accessible by client devices registered to a user. The global metadata corresponds to the media assets that are located remotely from one or more of the client devices. A client device can communicate a request for a media asset that is identified by the global metadata and located at a location remote from the client device.

### BACKGROUND

Users have an ever-increasing selection of media content to choose from that is available for consumption, such as music, photographs, videos, and other media assets. Additionally, a typical user may have several different devices on which media assets can be consumed, such as a desktop computer, a laptop computer, and a smart phone, and each particular device can store a different collection of the various types of media assets. Thus, a user may have several different collections of media assets distributed over multiple different devices.

Situations can arise when a user wants to access a particular media asset that is stored on a device, but the user may not have immediate access to the device. For example, a user may be utilizing a smart phone at a location away from home and wants to play a song that is stored on a desktop computer at the user's home. Typical ways of locating and retrieving the song for playback on the smart phone can be cumbersome and require a large amount of bandwidth. Thus, the user may spend a great deal of time transferring a media asset from the desktop computer to the smart phone, or the user may simply forego retrieving the media asset.

### SUMMARY

This summary is provided to introduce simplified concepts of synchronized distributed media assets. The simplified concepts are further described below in the Detailed Description. This summary is not intended to identify essential features of the claimed subject matter, nor is it intended for use in determining the scope of the claimed subject matter.

Synchronized distributed media assets is described. In embodiments, a global media catalog of global metadata is maintained for media assets that are accessible by client devices registered to a user. The global metadata can correspond to instances of the media assets that are located remotely from one or more of the client devices. A client device can be registered to the user based on a user identifier associated with the global media catalog that is maintained at a remote location from the client device. Local metadata for local media assets that are stored on the client device can then be aggregated with the global metadata in the global media catalog. Additionally, the global metadata can be communicated from the global media catalog for receipt by the client devices that are registered to the user for aggregation into a local media catalog at each of the client devices. A client device can then initiate a request for a media asset that is identified by the global metadata and located remotely from the client device.

In other embodiments, user preferences can be detected on a client device that is associated with a user identifier. Entries from a global media catalog can then be located that correspond to the user preferences. The global media catalog can be associated with the user identifier and maintained by a resource remote from the client device. Media assets can then be received that correspond to the entries in the global media catalog and that are located based on the user preferences. The media assets can then be retrieved from a different client device that is associated with the user identifier.

### BRIEF DESCRIPTION OF THE DRAWINGS

Embodiments of synchronized distributed media assets are described with reference to the following drawings. The same numbers are used throughout the drawings to reference like features and components:

FIG. 1 illustrates an example system in which embodiments of synchronized distributed media assets can be implemented.

FIG. 2 illustrates example method(s) for synchronized distributed media assets in accordance with one or more embodiments.

FIG. 3 illustrates example method(s) for synchronized distributed media assets in accordance with one or more embodiments.

FIG. 4 illustrates example method(s) for synchronized distributed media assets in accordance with one or more embodiments.

FIG. 5 illustrates example method(s) for synchronized distributed media assets in accordance with one or more embodiments.

FIG. 6 illustrates various components of an example device that can implement embodiments of synchronized distributed media assets.

### DETAILED DESCRIPTION

Embodiments of synchronized distributed media assets provide that a global media catalog is maintained that includes metadata for media assets stored on different devices that are associated with a particular user identifier. A user can utilize the user identifier to register a client device with the global media catalog. When registered, a local media catalog stored on the client device is synchronized with the global media catalog by aggregating metadata from the local media catalog into the global media catalog. Additionally, metadata from the global media catalog can be aggregated with the local media catalog at the client device to provide a catalog of metadata that describes media assets stored on the different devices that are associated with the user. The user can request, via the client device, a media asset that is stored on a different device. The media asset can be communicated (e.g., downloaded and/or uploaded) from the different device to a global media queue and made available to the client device (e.g., for download and/or streaming). Alternatively, the media asset can be communicated directly from the different devices to the requesting client device.

While features and concepts of the described systems and methods for synchronized distributed media assets can be implemented in any number of different environments, systems, and/or various configurations, embodiments of synchronized distributed media assets are described in the context of the following example systems and environments.

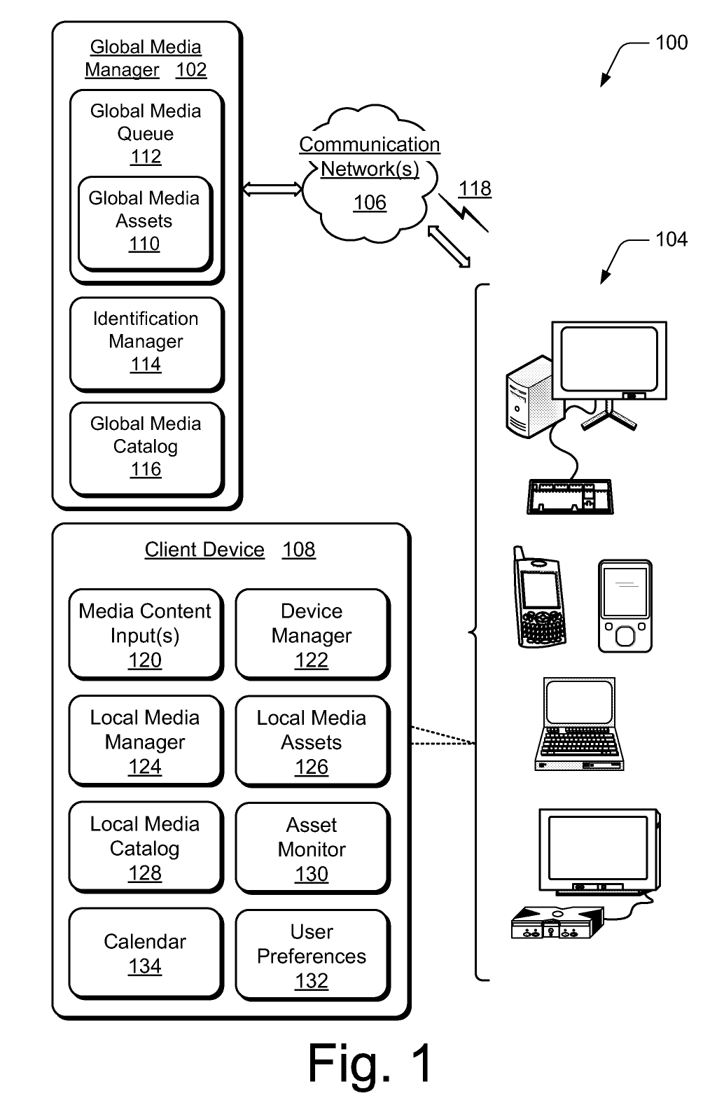

FIG. 1 illustrates an example system 100 in which various embodiments of synchronized distributed media assets can be implemented. System 100 includes a global media manager 102 implemented for media content management and distribution, as well as communication with various client devices 104 via communication network 106. The global media manager 102 can be implemented as one or more server devices to manage media assets for different users and a variety of different client devices for each of the users.

An example client device 108 is representative of the various client devices 104 that receive global media assets 110 when distributed from a global media queue 112 of the global media manager 102. In a media content distribution system, the global media manager 102 includes an identification manager 114 that facilities the registration of users and devices with the global media manager 102, as well as other authentication and verification tasks. In example implementations, an identifier, such as a user identifier, can be utilized to associate the client devices 104 with a particular user. Alternatively or in addition, the identifier can identify a particular client device and can be used to associate other client devices with the particular client device. In some implementations, a user can log on to the global media manager 102 via the client device 108, such as via a web page associated with the global media manager 102. When the user logs on to the global media manager 102, the global media manager can determine if one or more of the other client devices 104 are associated with the user and thus available for the retrieval of media assets for the user.

The global media manager 102 also includes a global media catalog 116 that maintains metadata for media assets that are stored by one or more of the client devices 104. Media content (e.g., to include recorded media content) can include media assets as any type of audio, video, and/or image data received from any media content and/or data source. Media assets can include, but are not limited to, television programs, movies, advertisements, music, video clips, interactive games, network-based applications, and any other content or data.

The communication network 106 can include any type of a data network, voice network, broadcast network, an IP-based network, and/or a wireless network 118 that facilitates communication of data and media content in any format. The communication network 106 can be implemented using any type of network topology and/or communication protocol, and can be represented or otherwise implemented as a combination of two or more networks. In addition, any one or more of the arrowed communication links facilitate two-way data communication.

The various client devices 104 in system 100 can be implemented as any one or combination of a wired and/or wireless device, as any form of computer device, portable computer device, consumer device, media device, communication device, video processing and/or rendering device, appliance device, electronic device, and/or as any other type of device that can be implemented to receive media content in any form of audio, video, and/or image data. A client device may also be associated with a user (i.e., a person) and/or an entity that operates the device such that a device describes logical devices that include users, software, firmware, and/or a combination of devices.

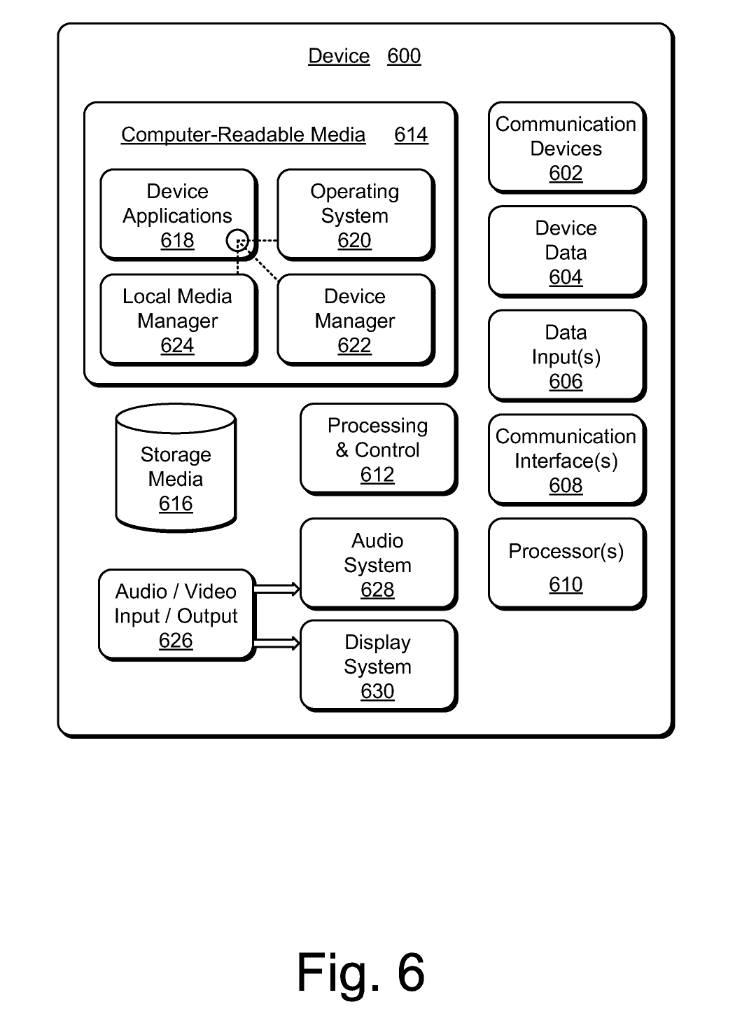

The example client device 108 is representative of the various client devices 104 that can implement embodiments of synchronized distributed media assets. Any of the devices described herein can be implemented with one or more processors, communication components, data inputs, memory components, processing and control circuits, and/or a media content rendering system. A device can also be implemented with any number and combination of differing components as described with reference to the example device shown in FIG. 6.

In this example, client device 108 includes media content inputs 120 to receive global media assets 110 from global media queue 112. Alternatively or in addition, the media content inputs 120 can receive media content directly from a different client device of the client devices 104. The media content inputs 120 can include any type of communication interfaces and/or data inputs, such as Internet Protocol (IP) inputs over which streams of data can be received via an IP-based network. Client device 108 can be implemented with a device manager 122 that can include any one or combination of a control application, software application, processing and control module, code that is native to the particular device, and/or a hardware abstraction layer for the particular device.

In this example, the client device 108 also includes a local media manager 124 that is implemented to generate requests for global media assets 110 as well as receive requests for local media assets 126. In an implementation, the local media assets 126 can be communicated to the global media queue 112 and included in the global media assets 110. Alternatively or in addition, one or more of the media assets from the local media assets 126 can be made available for direct access by any of the various client devices 104.

Client device 108 also includes a local media catalog 128 that is implemented to store metadata related to the local media assets 126, as well as metadata from the global media catalog 116. The local media catalog 128 can be synchronized with the global media catalog 116 on a periodic basis and/or responsive to a change in the global media catalog 116. In an implementation, a user can request a media asset that is listed in the local media catalog 128 but that is stored remotely (e.g., on a different one of the various client devices 104). The request for the media asset is communicated by the local media manager 124 to the global media manager 102. The global media manager 102 then locates one of the client devices 104 on which the requested media asset is stored and requests the media asset. The media asset is then communicated to the global media queue 112 and stored as part of the global media assets 110.

In some implementations, the requested media asset can then be downloaded by the client device 108 from the global media queue 112 and included in the local media assets 126 for consumption (e.g., playback, use, etc.) on the client device 108. Alternatively or in addition, the requested media asset can be streamed from the global media queue 112 for consumption on the client device 108. The requested media asset can then be deleted from the global media queue 112, thus conserving storage space in the global media queue. In some implementations, the global media queue 112 is configured to store a requested media asset until the media asset is communicated to the client device 108 (e.g., via download, upload, and/or streaming), after which the media asset is deleted from the global media queue.

In an implementation, the global media manager 102 can receive a request from one of the client devices 104 other than client device 108 for a media asset that is stored on the client device 108. The requested media asset can be communicated from the client device 108 to the global media queue 112 and made available (e.g., via download and/or streaming) to the requesting client device.

In this example, the client device 108 also includes an asset monitor 130 that is implemented to track media asset use, consumption, and/or playback with respect to the client device 108. For example, the asset monitor 130 can track which instances of the local media assets 126 are played most frequently, as well as genres of media assets that are consumed on the client device 108 and/or requested by a user of the client device. A genre can include any appropriate way of categorizing media content and/or media assets. For example, music genres can include rock, pop, country, soul, world music, and so on. Video genres can include comedy, action, drama, and so on. Genres can also be user-specified, such as personal media content (e.g., family photos), business-related content, recreational content, and so on. The asset monitor 130 can store user asset interaction information as user preferences 132, which can be used to locate media assets that may be of interest to a user of the client device 108.

A calendar 134 is implemented to track events associated with the client device 108. For example, a user can record events (e.g., business meetings, social events, and so on) utilizing the calendar 134. The asset monitor 130 can access the calendar 134 and determine event information that may be utilized to locate appropriate media assets to be requested on the client device 108. In an implementation, events from the calendar 134 may be utilized along with the user preferences 132 to locate media assets for consumption on the client device 108.

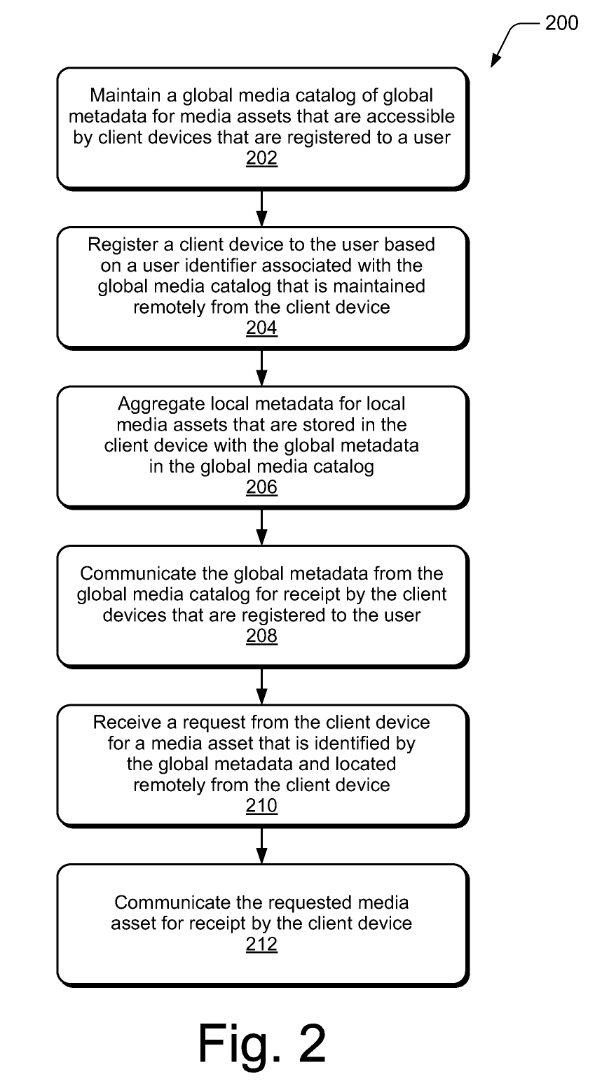

Example methods 200-500 are described with reference to respective FIGS. 2-5 in accordance with one or more embodiments of synchronized distributed media assets. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. The example methods may be described in the general context of computer-executable instructions, which can include software, applications, routines, programs, objects, components, data structures, procedures, modules, functions, and the like.

The methods may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 2 illustrates example method(s) 200 of synchronized distributed media assets. The order in which the method is described is not intended to be construed as a limitation, and any number of the described method blocks can be combined in any order to implement the method, or an alternate method.

At block 202, a global media catalog is maintained of global metadata for media assets that are accessible by client devices that are registered to a user. For example, the global media catalog 116 maintains metadata for media assets that is stored on the client devices 104. Metadata can include information about media assets, such as song titles, video titles, genres, file sizes, digital rights management information, user identification information, and so on.

At block 204, a client device is registered to the user based on a user identifier associated with the global media catalog that is maintained remotely from the client device. For example, the client device 108 is registered with the global media manager 102, which provides the client device 108 with access to the global media catalog 116. At block 206, local metadata for local media assets that are stored in the client device is aggregated with the global metadata in the global media catalog. For example, metadata from the local media catalog 128 is aggregated with the global media catalog 116.

At block 208, the global metadata from the global media catalog is communicated for receipt by the client devices that are registered to the user. For example, metadata from the global media catalog 116 is communicated to the client device 108 and added to the local media catalog 128. Thus, the local media catalog 128 can include metadata for media assets that are stored on the client devices 104. The metadata can be utilized to create a list of media assets that can be requested via the client device 108.

At block 210, a request from the client device is received for a media asset that is identified by the global metadata and located remotely from the client device. For example, a user can request (e.g., via input to the client device 108) a media asset that is identified in the global media catalog 116 and stored in one of the other client devices 104. A user can initiate a request for a media asset with any type of user input from a list of media assets that is displayed at the client device 108.

At block 212, the requested media asset is communicated for receipt by the client device. For example, the media asset can be communicated from the one of the other client devices 104 and stored as part of the global media assets 110 in the global media queue 112. The client device 108 can then download the media asset from the global media queue 112. Alternatively or in addition, the media asset can be streamed from the global media manager 102 to the client device 108 for streaming consumption. In an implementation, when the media asset has been downloaded and/or streamed to the client device 108, the media asset can be deleted from the global media queue 112.

In various embodiments, a media asset can be stored in a format that may not be supported by a requesting device (e.g., one of the client devices 104). Example formats can include any type of file format, such as audio formats (e.g., WMA, WAV, MP3, OGG, and so on), video formats (e.g., MPEG, MOV, WAV, and so on), image formats (e.g., JPEG, BMP, TIFF, and so on), and/or any other format that can be utilized to encode and/or store the media asset. The media asset may then be converted to a different format before it is consumed on a device. In an implementation, the global media manager 102 can implement transcoding functionality that transcodes media content between different formats. When the global media manager 102 receives a media asset in response to a request for the media asset from the client device 108, the global media manager 102 can determine if the media asset is in a format that is supported by the client device 108. If the media asset is in a format that is not supported by the client device 108, the global media manager 102 can convert the media asset into a format that is supported by the client device 108.

Alternatively or in addition, the global media manager 102 can determine, prior to receiving a media asset, that the media asset is in a format that is not supported by the client device 108. The global media manager can then request that the media asset be transcoded into a format that is supported by the client device 108 before the media asset is communicated to the global media queue 112. Transcoding tasks can be performed by one or more of the client devices 104 that stores media assets and/or by the global media manager 102.

In some implementations, digital rights management (DRM) information can be considered before a media asset is uploaded to the global media queue 112 and/or made available for consumption on one or more of the client devices 104. For example, when a media asset is requested from the global media manager 102 by one of the client devices 104, the global media manager 102 can inspect metadata associated with the requested media asset for DRM information. If the metadata associated with the requested media asset includes DRM information, and the DRM information indicates that the media asset may be transferred to another device, the media asset can be communicated to the global media queue 112 and made available to the requesting device. Alternatively or in addition, information that is utilized to access a media asset can also be transferred with the media asset, such as a certificate, a password, a license, and so on.

Alternatively, if the DRM information indicates that the media asset may not be transferred (e.g., transfer of the media asset is not allowed under license terms), the global media manager 102 can communicate a notification to the requesting client device that the media asset is not available. Alternatively or in addition, the global media manager can determine if a different copy of the media asset is available that may be made available to the requesting device (e.g., a copy with DRM information that indicates that the media asset may be transferred to another device).

In various implementations, DRM information can be utilized to determine if a media asset is be listed in the global media catalog 116. For example, when the client device 108 is registered with the global media manager 114 and the local media catalog 128 is synchronized with the global media catalog 116, the global media manager can inspect metadata from the local media catalog 128 for DRM information. If the global media manager 102 detects DRM information that indicates that a particular media asset may not be transferred or performed on another device, the media asset may be omitted from the global media catalog 116. Accordingly, the global media catalog may be filtered to only include entries for instances of media assets having DRM information that indicates which of the media assets may be transferred to and/or consumed on other devices.

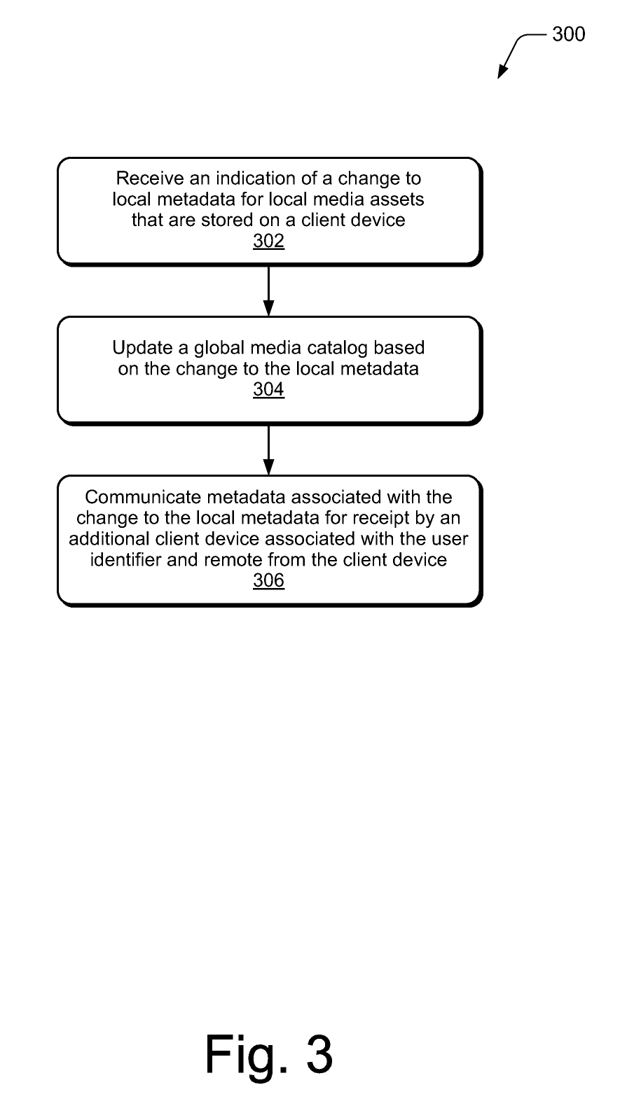

FIG. 3 illustrates example method(s) 300 of synchronized distributed media assets. The order in which the method is described is not intended to be construed as a limitation, and any number of the described method blocks can be combined in any order to implement the method, or an alternate method.

At block 302, an indication is received of a change to local metadata for local media assets that are stored on a client device. For example, a new media asset can be loaded onto the client device 108, and metadata for the new media asset can be added to the local media catalog 128.

At block 304, a global media catalog is updated based on the change to the local metadata. For example, periodic synchronization events can occur when new metadata in the local media catalog 128 is added to the global media catalog 116, and when new metadata in the global media catalog 116 is added to the local media catalog 128. Alternatively or in addition, the client device 108 can display a user interface that is populated with information from the global media catalog 116. Thus, in various embodiments, metadata from the global media catalog may not be stored on the client device 108, but rather, can be provided to the client device via a user interface, such as a web page that is associated with the global media manager 102.

At block 306, metadata associated with the change to the local metadata is communicated for receipt by an additional client device associated with the user identifier and remote from the client device. For example, new metadata in the local media catalog 128 can be communicated to update a local media catalog of a different one of the client devices 104. Thus, metadata synchronization can occur between the client device 108 and the global media manager 102, as well as between the various client devices 104.

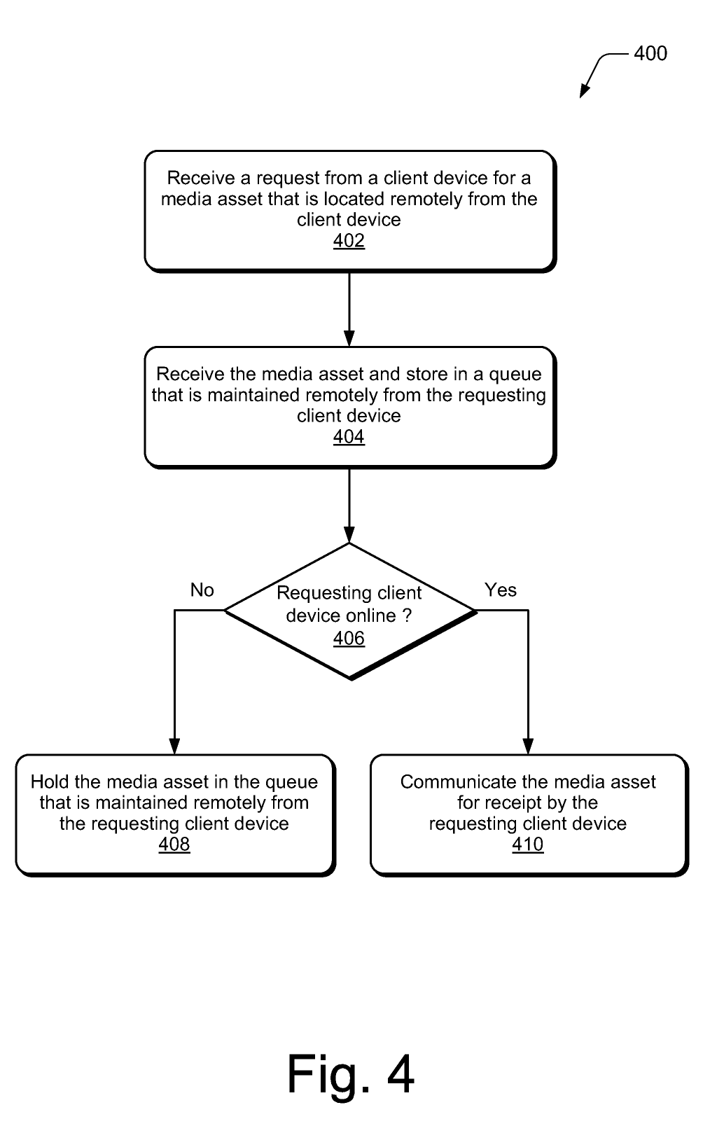

FIG. 4 illustrates example method(s) 400 of synchronized distributed media assets. The order in which the method is described is not intended to be construed as a limitation, and any number of the described method blocks can be combined in any order to implement the method, or an alternate method.

At block 402, a request from a client device is received for a media asset that is located remotely from the client device. For example, a user of the client device 108 requests a media asset that is listed in the global media catalog 116 and stored at one of the other client devices 104. At block 404, the media asset is received and stored in a queue that is maintained remotely from the requesting client device. For example, the media asset is stored as part of the global media assets 110 in the global media queue 112.

At block 406, a determination is made as to whether the client device that requested the media asset is online. For example, the global media manager 102 can ping the client device 108 to determine if the client device 108 is online. If the client device that requested the media asset is not online (i.e., “no” from block 406), then at block 408 the media asset is held in the queue that is maintained remotely from the requesting client device. For example, the global media manager 102 determines that the client device 108 is not online (e.g., offline) and holds the media asset in the global media queue 112.

If the client device that requested the media asset is online (i.e., “yes” from block 406), then at block 410 the media asset is communicated for receipt by the requesting client device. For example, the media asset is communicated from the global media queue 112 to the local media assets 126. Alternatively or in addition, the media asset can be streamed from the global media queue 112 for consumption by the client device 108.

In various implementations, communication of media assets from one of the client devices 104 to the global media queue 112, and/or communication of media assets from the global media queue 112 to one of the client devices 104 can be scheduled based on bandwidth usage. For example, if a request for a media asset is made during a high bandwidth usage time (e.g., during the middle of the business day), communication of the requested media asset can be scheduled for a lower bandwidth usage time, such as early morning hours. The global media manager 102 can store the media asset in the global media queue 112 until bandwidth usage falls below a certain threshold, at which time the media asset is communicated to the client device 108.

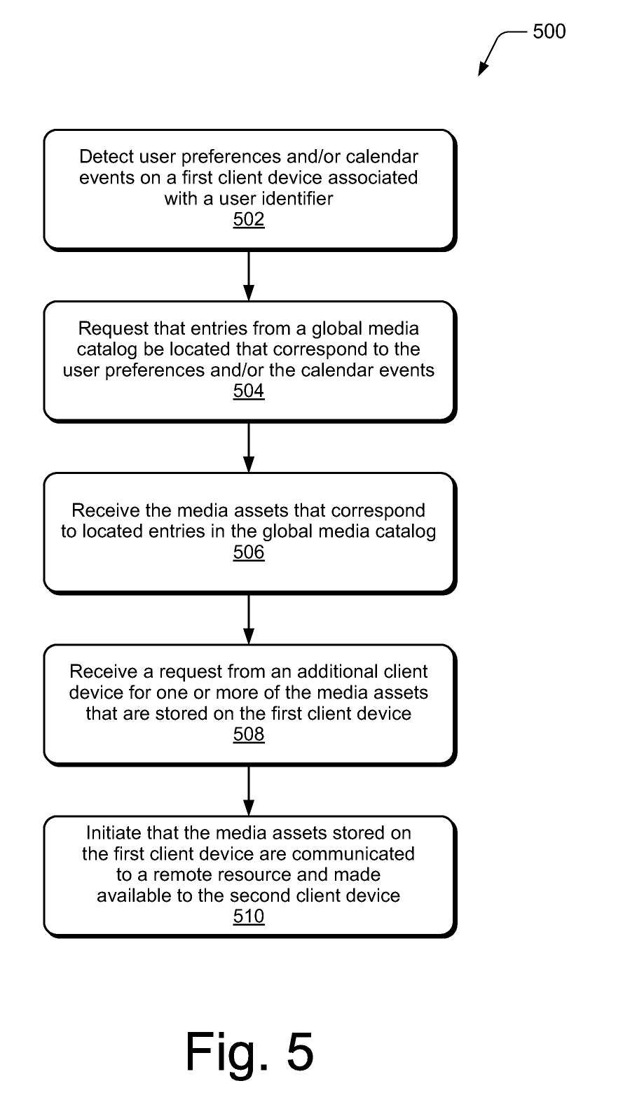

FIG. 5 illustrates example method(s) 500 of synchronized distributed media assets. The order in which the method is described is not intended to be construed as a limitation, and any number of the described method blocks can be combined in any order to implement the method, or an alternate method.

At block 502, one or more user preferences and/or calendar events are detected on a first client device associated with a user identifier. For example, the user preferences 132 and/or one or more events from the calendar 134 are detected. The user preferences 132 can be automatically detected by the asset monitor 130 responsive to media asset interactions on the client device 108. Alternatively or in addition, a user can provide feedback related to the user's preferences, such as by expressly selecting particular genres and/or categories of media content.

At block 504, a request is initiated to locate one or more entries from a global media catalog that correspond to the one or more user preferences and/or the calendar events. For example, the local media manager 124 provides one or more of the user preferences 132 to the global media manager 102 with a request that one or more instances of media content (e.g., media assets) be located that correspond to the user preferences. The global media manager 102 can use metadata associated with the user preferences to locate one or more entries in the global media catalog 116 that correspond to the user preferences 132. For example, if the user preferences 132 indicate that the user often plays music from the hard rock genre, one or more entries from the global media catalog 116 can be located that correspond to the hard rock genre.

In an example implementation, calendar events from the calendar 134 can be utilized to locate media assets. For example, the user preferences 132 can indicate that during scheduled workout events indicated by the calendar 134, music from the pop rock genre is often consumed on the client device 108. When the calendar 134 indicates that at a time in the near future a workout is scheduled, the local media manager 124 can request that music from the pop rock genre be located in the local media catalog 128 and/or the global media catalog 116. The music from the pop rock genre can then be communicated for receipt by the client device 108 and/or made available for streaming to the client device 108 prior to and/or in time for the scheduled workout.

At block 506, one or more of the media assets are received that correspond to located entries in the global media catalog. For example, the media assets that are stored on one or more of the various client devices 104 are communicated to the global media queue 112 and made available to the client device 108.

At block 508, a request is received from an additional client device for one or more of the media assets that are stored on the first client device. For example, one of the client devices 104 requests one or more media assets from the global media manager 102. The global media manager 102 then determines that the requested media assets are stored on the client device 108 (e.g., as part of the local media assets 126). The global media manager 102 then communicates a request to the client device 108 (e.g., to the local media manager 124) for the media assets.

At block 510, the media assets that are stored on the first client device are communicated to a remote resource and made available to the second client device. For example, the media assets can be uploaded from the local media assets 126 to the global media queue 112. The media assets can then be communicated to the second client device, such as via download and/or for streaming consumption.

FIG. 6 illustrates various components of an example device 600 that can be implemented as any type of client device and/or global media manager as described with reference to FIG. 1 to implement embodiments of synchronized distributed media assets. In embodiments, device 600 can be implemented as any one or combination of a wired and/or wireless device, as any form of television client device (e.g., television set-top box, digital video recorder (DVR), etc.), consumer device, computer device, portable computer device, media device, communication device, video processing and/or rendering device, appliance device, gaming device, electronic device, and/or as any other type of device. Device 600 may also be associated with a user (i.e., a person) and/or an entity that operates the device such that a device describes logical devices that include users, software, firmware, and/or a combination of devices.

Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image data. Device 600 also includes one or more data inputs 606 via which any type of data, media content, and/or inputs can be received, such as user-selectable inputs, messages, music, television media content, recorded video content, and any other type of audio, video, and/or image data received from a content source and/or data source.

Device 600 also includes communication interfaces 608 that can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices can communicate data with device 600.

Device 600 can include one or more processors 610 (e.g., any of microprocessors, controllers, and the like) which process various computer-executable instructions to control the operation of device 600 and to implement embodiments of synchronized distributed media assets. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 can also include computer-readable media 614, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable media 614 provides data storage mechanisms to store the device data 604, as well as various device applications 618 and any other types of information and/or data related to operational aspects of device 600. For example, an operating system 620 can be maintained as a computer application with the computer-readable media 614 and executed on processors 610. The device applications 618 can include a device manager 622 (e.g., a control application, software application, signal processing and control module, code that is native to a particular device, a hardware abstraction layer for a particular device, etc.). The device applications 618 can also include any system components or modules of a local media manager 624 to implement embodiments of synchronized distributed media assets. In this example, the device applications 618 are shown as software modules and/or computer applications.

Device 600 can also include an audio and/or video input-output system 626 that provides audio data to an audio system 628 and/or provides video data to a display system 630. The audio system 628 and/or the display system 630 can include any devices that process, display, and/or otherwise render audio, video, and image data. Video signals and audio signals can be communicated from device 600 to an audio device and/or to a display device via an RF (radio frequency) link, S-video link, composite video link, component video link, DVI (digital video interface), analog audio connection, or other similar communication link. In an embodiment, audio system 628 and/or the display system 630 can be implemented as external components to device 600. Alternatively, the audio system 628 and/or the display system 630 can be implemented as integrated components of example device 600.

Although embodiments of synchronized distributed media assets have been described in language specific to features and/or methods, it is to be understood that the subject of the appended claims is not necessarily limited to the specific features or methods described. Rather, the specific features and methods are disclosed as example implementations of synchronized distributed media assets.

1. A method implemented by a server device, the method comprising:
maintaining a global media catalog of global metadata for media assets that are accessible by client devices that are registered to a user, the global metadata corresponding to one or more instances of the media assets that are located remotely from at least one of the client devices;
registering a client device to the user based on a user identifier associated with the global media catalog, the global media catalog being maintained remotely from the client device;
aggregating local metadata for local media assets that are stored on the client device with the global metadata in the global media catalog; and
communicating the global metadata from the global media catalog for receipt by the client devices that are registered to the user, the client device being configured to initiate a request for a media asset that is identified by the global metadata and located remotely from the client device.

2. A method as recited in claim 1, further comprising:
receiving an indication of a change to the local metadata for the local media assets that are stored on the client device;
initiating an update to the global media catalog based on the change to the local metadata; and
initiating, responsive to the update to the global media catalog, metadata associated with the change to the local metadata to be communicated for receipt by an additional client device associated with the user identifier and remote from the client device.

3. A method as recited in claim 1, further comprising:
receiving a request from the client device for the media asset that is identified by the global metadata and located remotely from the client device;
initiating an upload of the media asset to a queue that is maintained remotely from the client device; and
communicating the media asset from the queue that is maintained remotely from the client device for receipt by the client device.

4. A method as recited in claim 3, further comprising initiating a deletion of the media asset from the queue that is maintained remotely from the client device.

5. A method as recited in claim 1, further comprising:
receiving a request from the client device for the media asset that is identified by the global metadata and located remotely from the client device;
responsive to a determination that the client device is offline, holding the media asset in a queue that is maintained remotely from the client device; and
responsive to a determination that the client device is online, initiating communication of the media asset for receipt by the client device.

6. A method as recited in claim 1, further comprising:
receiving a request from the client device for the media asset that is identified by the global metadata and located remotely from the client device; and
transcoding the instance of media asset into a media format that is supported by the client device.

7. A method as recited in claim 1, further comprising:
receiving an indication of one or more user preferences associated with consumption of the media assets on the client device;
locating global metadata that corresponds to the one or more user preferences; and
causing one or more of the media assets associated with the global metadata that corresponds to the one or more user preferences to be available for consumption by the client device.

8. A method as recited in claim 7, further comprising streaming the one or more media assets associated with the global metadata that corresponds to the one or more user preferences to the client device.

9. A method as recited in claim 7, further comprising downloading the one or more media assets associated with the global metadata that corresponds to the one or more user preferences to the client device.

10. A server system, comprising:
at least a memory and a processor configured to manage a global media catalog of global metadata for media assets that are accessible by one or more client devices that are registered to a user, the global metadata corresponding to one or more instances of the media assets that are located remotely from at least one of the one or more client devices;
a global media manager configured to:
register a client device to the user based on a user identifier associated with the global media catalog, the global media catalog being maintained remotely from the client device;
aggregate local metadata for instances of local media assets that are stored in the client device with the global metadata in the global media catalog; and
initiate communication of the global metadata from the global media catalog to the one or more client devices that are registered to the user, the client device being configured to initiate a request for a media asset that is identified by the global metadata and located remotely from the client device.

11. The server system as recited in claim 10, further comprising a global media queue configured to receive the media asset that is identified by the global metadata responsive to the request from the client device for the media asset that is identified by the global metadata.

12. The server system as recited in claim 10, wherein the global media manager is further configured to:
receive a request from the client device for the media asset that is identified by the global metadata and located remotely from the client device;
communicate the request for the media asset to an additional client device that is associated with the user identifier and located remotely from the client device; and
cause the media asset to be available to the client device.

13. The server system as recited in claim 10, wherein the global media manager is further configured to:
receive a request from the client device for the media asset that is identified by the global metadata and located remotely from the client device; and
determine if digital rights management information indicates whether the media asset may be consumed by the client device.

14. The server system as recited in claim 10, wherein the global media manager is further configured to:
receive a request to register an additional client device that is remote from the client device, the request including the user identifier associated with the global media catalog;
aggregate local metadata for instances of local media assets that are stored in the additional client device with the global metadata in the global media catalog; and
initiate communication of the global metadata from the global media catalog to the additional client device.

15. The server system as recited in claim 10, wherein the global media manager is further configured to:
receive an indication of one or more user preferences based on media asset consumption on the client device;
determine, based on the global metadata, one or more instances of media assets that correspond to the user preferences; and
cause the one or more instances of the media assets that correspond to the user preferences to be available for consumption by the one or more client devices associated with the user identifier.

16. The server system as recited in claim 10, wherein the global media manager is further configured to:
receive a request from the client device for the media asset that is identified by the global metadata and located remotely from the client device;
responsive to a determination that the client device is offline, hold the media asset in a global media queue that is maintained by the global media manager; and
responsive to a determination that the client device is online, initiate communication of the media asset from the global media queue for receipt by the client device.

17. Computer-readable media having stored thereon computer-executable instructions that, if executed by a computer device, initiate the computer device to:
detect one or more user preferences on a first client device associated with a user identifier;
request that media assets identified in a global media catalog be located that corresponds to the one or more user preferences, the global media catalog being associated with the user identifier and maintained by a resource remote from the client device; and
receive one or more instances of the media assets that are identified in the global media catalog, the one or more instances of the media assets being retrieved from a second client device that is associated with the user identifier.

18. Computer-readable media as recited in claim 17, wherein the computer-executable instructions, if executed, further initiate the computer device to:
detect one or more calendar events associated with a calendar maintained by the first client device; and
request that additional media assets identified in the global media catalog be located that corresponds to the one or more user preferences and the one or more calendar events.

19. Computer-readable media as recited in claim 17, wherein the computer-executable instructions, if executed, further initiate the computer device to:
receive an indication that an additional client device has requested a media asset that is stored on the first client device; and
initiate that the media asset stored on the first client device be uploaded to a remote resource that is remote to the first client device and to the additional client device, the remote resource configured to initiate that the media asset is available to the additional client device.

20. Computer-readable media as recited in claim 17, wherein the one or more user preferences are based on one or more genres of the media assets that are consumed on the first client device.
